(19) United States
(12) Patent Application Publication
(10) Pub. No.: US 2007/0085970 A1
(43) Pub. Date: Apr. 19, 2007

(54) IMAGE DISPLAY DEVICE

(75) Inventor: Shohei YOSHIDA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/539,073

(22) Filed: Oct. 5, 2006

(30) Foreign Application Priority Data
Oct. 5, 2005 (JP) 2005-292099

(51) Int. Cl. G03B 21/14

(52) U.S. Cl. 353/20

(57) ABSTRACT

An image display device includes an illumination device, and a light valve that modulates a light coming from the illumination device. In the image display device, the light valve includes an electro-optical panel configured by a pair of substrates sandwiching therebetween an electro-optical material that shows refractive index anisotropy in response to application of an electric field when being optically isotropic. In the electro-optical panel, the application of the electric field is directed between the pair of substrates, and in the illumination device, the amount of light entering the light valve at a predetermined light incident angle is larger than the amount of light coming from the direction of a normal of the light valve.

### BACKGROUND

1. Technical Field

The present invention relates to an image display device.

2. Related Art

Polymer-stabilized liquid crystal blue phases are currently under study. As an example, refer to Non-Patent Document 1 (Hirotsugu KIKUCHI, “Expanding New Fields in Liquid Crystals with Polymer and Chiral Effects-Anomalous Kerr Effect of Isotropic Liquid Crystals-”, EKISHO, Japanese Liquid Crystal Society, Vol. 9, No. 2, Apr. 25, 2005, p.82(14)-95(27)). The blue phase is a liquid crystal phase that is optically isotropic, and appears in a narrow temperature range between a chiral nematic phase and an isotropic phase. The blue phase is named as it often looks blue. Although the blue phase did not attract much attention for a long time due to its narrow temperature range, there found that the blue phase is dramatically stabilized by introducing a small amount of polymer there into. Herein, the expression of “stabilized” by a small amount of polymer means increasing the temperature range for the blue phase to appear without impairing the high molecular mobility originally expected in the liquid crystals.

The blue phase is known to show the Kerr effect, which is a phenomenon of exciting the birefringence with an optical axis being the direction of an electric field. The birefringence is proportional to the square of the electric field intensity. Such a phenomenon occurs in response to when a polarized material being isotropic is applied with an electric field. That is, the blue phase shows refractive index anisotropy by application of an electric field when it is in the state of optically isotropic. The blue phase is also known to have a considerably high speed of response.

FIGS. 10A and 10B are both a schematic cross sectional view of a liquid crystal panel with a blue phase. FIG. 10A shows the state of no application of electric field, and FIG. 10B shows the state of application of electric field. With a general liquid crystal panel configured by a pair of substrates with a liquid crystal material sandwiched therebetween, the birefringence of the liquid crystal material, i.e., refractive index anisotropy, is utilized to control (modulate) the transmittance of the incident light. In consideration thereof, as shown in FIG. 10B, a liquid crystal panel 40 with a blue phase includes a pair of electrodes 47 and 48 formed on the inner surface of one substrate 49, and an electric field is applied in the direction horizontal to the substrate 49. This enables modulation of a light 91 coming from the direction of a normal of the substrate 49.

The issue here is that such a liquid crystal panel 40 involves tradeoffs between an aperture ratio and an application voltage. That is, if the space between the electrodes 47 and 48 is narrowed to reduce the application voltage, this also reduces the aperture ratio. If the space between the electrodes 47 and 48 is widened to increase the aperture ratio, this requires a higher level of voltage for application of any predetermined electric field.

### SUMMARY

An advantage of some aspects of the invention is to provide an image display device that is capable of increasing the aperture ratio and reducing the power consumption at the time of optical modulation using such an electro-optical material as above.

A first aspect of the invention is directed to an image display device including an illumination device, and a light valve that modulates a light coming from the illumination device. In the device, the light valve includes an electro-optical panel configured by a pair of substrates sandwiching therebetween an electro-optical material that shows refractive index anisotropy in response to application of an electric field when being optically isotropic. In the electro-optical panel, the application of the electric field is directed between the substrate pair, and in the illumination device, the amount of light entering the light valve with a predetermined light incident angle is larger than the amount of light coming from the direction of a normal of the light valve.

In the first aspect, the electro-optical material has a liquid crystal phase at least by the application of the electric field.

In the configuration, the amount of light entering the light valve with a predetermined light incident angle is made larger than the amount of light coming from the direction of a normal of the light valve. This accordingly enables to perform optical modulation through application of an electric field between a pair of substrates sandwiching therebetween the electro-optical material. At this time, the electric field is applied in the direction vertical to the substrates so that the aperture ratio can be increased and the power consumption can be favorably reduced compared with a case of applying the electric field in the direction horizontal to the substrates. The electro-optical material has a higher speed of response so that the resulting image display device can have good characteristics of displaying moving images.

In the first aspect, preferably, the light valve is provided with a pair of polarizer plates that are disposed before and after the electro-optical panel in an optical axis direction of the illumination device. The pair of polarizer plates is disposed to derive substantial orthogonality between their polarizer axes, and the illumination device is configured to maximize, in the light entering the light valve, the amount of light coming from the direction with an azimuth angle of substantially 45 degrees with respect to the direction of the polarizer axes of the polarizer plates.

With the light valve configured only by a pair of polarizer plates disposed before and after the electro-optical panel, the light coming from the direction of the polarizer axes of the polarizer plates is minimum in transmittance, and the light coming from the direction with an azimuth angle of substantially 45 degrees with respect to the direction of the polarizer axes of the polarizer plates is maximum in transmittance. Accordingly, the illumination device is configured to maximize the amount of light coming from the direction with an azimuth angle of substantially 45 degrees with respect to the direction of the polarizer axes of the polarizer plates, whereby the illumination light can be increased in usage efficiency.

In the first aspect, still preferably, the illumination device includes: a light source; a first fly eye lens that divides a light from the light source into a plurality of luminous fluxes for light gathering; a second fly eye lens that collimates a main beam of each of the luminous fluxes; and an superimpose lens that superimposes each of the luminous fluxes on the light valve. In the illumination device, a plurality of small lenses configuring the second fly eye lens are disposed with a space from an optical axis of the illumination device.

With such a configuration, the light can be directed to the light valve in the oblique direction, i.e., the amount of light entering the light valve with a predetermined incident angle can be made larger than the amount of light entering the light valve from the direction of a normal thereof. This favorably enables to perform optical modulation through application of an electric field between a pair of substrates sandwiching therebetween the above-described electro-optical material.

In the first aspect, as an alternative configuration, the illumination device may include: a plurality of small light sources configuring a light source; a first fly eye lens that gathers luminous fluxes coming from the small light sources; a second fly eye lens that collimates a main beam of each of the luminous fluxes; and an superimpose lens that superimposes each of the luminous fluxes on the light valve. In the illumination device, the small light sources, a plurality of first small lenses configuring the first fly eye lens, and a plurality of second small lenses configuring the second fly eye lens are each disposed with a space from the optical axis of the illumination device.

Also with this configuration, the light can be directed to the light valve in the oblique direction, i.e., the amount of light entering the light valve with a predetermined incident angle can be made larger than the amount of light entering the light valve from the direction of a normal thereof. This favorably enables to perform optical modulation through application of an electric field between a pair of substrates sandwiching therebetween the above-described electro-optical material.

In this configuration, preferably, the small light sources, the first small lenses, and the second small lenses are all disposed mainly in the direction forming an azimuth angle of substantially 45 degrees with respect to the direction of a polarizer axis of a polarizer plate of the light valve.

Accordingly, the illumination light can be directed to the light valve from, mainly, the direction with an azimuth angle of substantially 45 degrees with respect to the direction of polarizer axes of the polarizer plates, whereby the illumination light can be increased in usage efficiency.

Alternatively, the illumination device may include a light source, and a light guide element that guides a light from the light source to the light valve, and the light guide element may be shaped tapered from the side of the light source toward the side of the light valve.

Also with this configuration, the light can be directed to the light valve in the oblique direction, i.e., the amount of light entering the light valve with a predetermined incident angle can be made larger than the amount of light entering the light valve from the direction of a normal thereof. This favorably enables to perform optical modulation through application of an electric field between a pair of substrates sandwiching therebetween the above-described electro-optical material.

Still alternatively, the illumination device may include: a plurality of small light sources configuring a light source; and a plurality of light guide elements that guide a light coming from each of the small light sources to the light valve. In the illumination device, each of the light guide elements is shaped tapered from the side of the small light sources toward the side of the light valve.

Also with this configuration, the light can be directed to the light valve in the oblique direction, i.e., the amount of light entering the light valve with a predetermined incident angle can be made larger than the amount of light entering the light valve from the direction of a normal thereof. This favorably enables to perform optical modulation through application of an electric field between a pair of substrates sandwiching therebetween the above-described electro-optical material.

In the configuration, preferably, the optical axis of the illumination device is disposed to intersect the direction of a normal of the electro-optical panel.

Also with this configuration, the light can be directed to the light valve in the oblique direction, i.e., the amount of light entering the light valve with a predetermined incident angle can be made larger than the amount of light entering the light valve from the direction of a normal thereof. This favorably enables to perform optical modulation through application of an electric field between a pair of substrates sandwiching therebetween the above-described electro-optical material. What is more, this configuration is applicable to any general illumination device so that the resulting image display device can be provided at lower cost.

Herein, preferably, the optical axis of the illumination device is disposed to form an azimuth angle of substantially 45 degrees with respect to the direction of a polarizer axis of a polarizer plate of the light valve.

Accordingly, the illumination light can be directed to the light valve from, mainly, the direction with an azimuth angle of substantially 45 degrees with respect to the direction of polarizer axes of the polarizer plates, whereby the illumination light can be increased in usage efficiency.

Herein, the electro-optical panel is preferably of a reflective type

With the reflective electro-optical panel, the space between a pair of substrates can be reduced, thereby leading to the reduction of power consumption. Moreover, the speed of response can be increased for the electro-optical material so that the resulting image display device can have the good characteristics of displaying moving images.

The light valve preferably includes a pair of circular polarizer plates that are disposed before and after the electro-optical panel in an optical axis direction of the illumination device.

With such a configuration, the transmittance of the light constant in level as the transmittance of the light independent from azimuth angle. This accordingly enables to widen the angle range of highly transmittal so that the resulting image display device can have the good display quality.

Herein, preferably, the circular polarizer plates are configured by including, between the electro-optical panel and the polarizer plates, a wave plate having a phase difference of substantially a quarter wavelength with respect to a wavelength of a visible light.

This configuration enables to configure the circular polarizer plates at lower cost.

### BRIEF DESCRIPTION OF THE DRAWINGS

The invention will be described with reference to the accompanying drawings, wherein like numbers reference like elements.

FIG. 1 is a schematic diagram showing the configuration of an image display device in a first embodiment.

FIGS. 2A and 2B are both a schematic cross sectional view of a light valve.

FIGS. 3A and 3B are both an exploded perspective view of the light valve.

FIGS. 4A and 4B are both an iso-transmittance curve in bright display.

FIGS. 5A and 5B are both a diagram showing the configuration of an illumination device in the first embodiment.

FIG. 6 is a schematic diagram showing the configuration of an illumination device in a first modified example of the first embodiment.

FIGS. 7A and 7B are both a schematic diagram showing the configuration of an illumination device in a second modified example of the first embodiment.

FIG. 8 is a schematic diagram showing the configuration of an illumination device in a third modified example of the first embodiment.

FIGS. 9A and 9B are both a schematic diagram showing the configuration of an image display device of a second embodiment.

FIGS. 10A and 10B are both a schematic cross sectional view of a liquid crystal panel of a related art.

### DESCRIPTION OF EXEMPLARY EMBODIMENTS

In the below, embodiments of the invention are described by referring to the accompanying drawings. Note that, in the drawings for use of description below, the scaling is appropriately changed to show the components with size good for perception.

First Embodiment

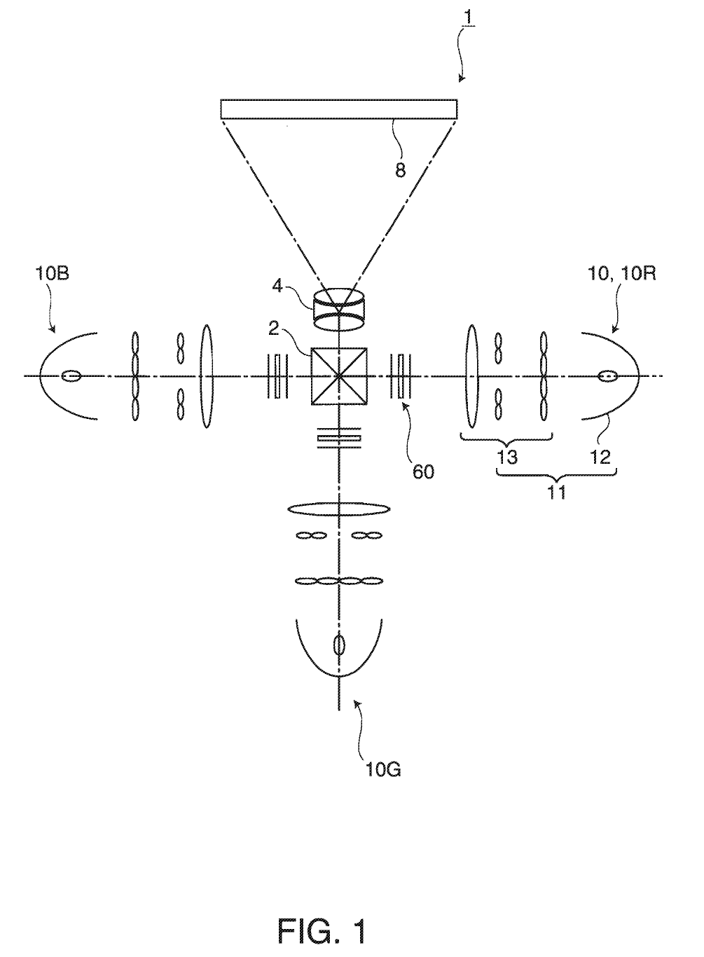

By referring to FIGS. 1 to 5B, described first is an image display device in a first embodiment of the invention. FIG. 1 is a schematic diagram showing the configuration of the image display device in the first embodiment.

Image Display Device

As shown in FIG. 1, an image display device 1 of this embodiment is a projection-type image display device, i.e., projector. The image display device 1 carries, at the center portion, a rectangular-shaped cross dichroic prism 2. In three directions of the cross dichroic prism 2, disposed are color systems of red 10R, green 10G, and blue 10B. In the remaining one direction, a projection lens system 4 is disposed. As will be described later, because the light entering the projection lens system 4 has a larger incident angle, the projection lens may desirably have a small F value.

The cross dichroic prism 2 is configured by four right-angle prisms attached together. On an interface of such a cross dichroic prism 2, a dielectric multilayer reflecting red lights and another dielectric multilayer reflecting blue lights are disposed, substantially, in a shape of the letter X. Color image lights coming from the color systems 10R, 10G, and 10B are combined in the cross dichroic prism 2, and the resulting combined image light is directed to the projection lens system 4. The projection lens system 4 enlarges and projects the combined image light onto a screen 8 so that color images are displayed on the screen 8.

Light Valve

The color systems 10 are each configured by an illumination device 11 that illuminates a light valve 60, and the light valve 60 that modulates lights coming from the illumination device 11 into image lights.

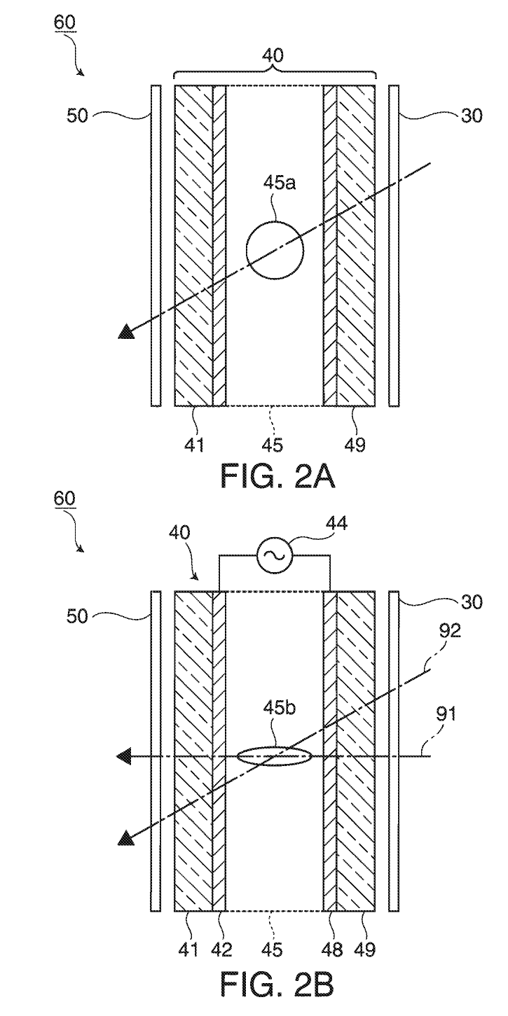

FIGS. 2A and 2B are both a schematic cross sectional view of the light valve. Specifically, FIG. 2A shows the state of no application of electric field, and FIG. 2B shows the state of application of electric field. As shown in FIG. 2A, the light valve 60 is configured by a liquid crystal panel 40, and a pair of polarizer plates 30 and 50 that are disposed before and after the liquid crystal panel. The liquid crystal panel 40 includes a pair of substrates 41 and 49 made of a transparent material such as glass, and a liquid crystal material 45 is sandwiched therebetween. The liquid crystal material 45 is of so-called blue phase.

The blue phase is a liquid crystal phase that is optically isotropic, and appears in a narrow temperature range between a chiral nematic phase and an isotropic phase (for example, refer to Non-Patent Document 1). Although the blue phase has not attracted much attention for a long time due to its narrow temperature range, e.g., of about 1K, there found that the blue phase is dramatically stabilized with a small amount of polymer. Herein, the expression of “stabilized” by a small amount of polymer means increasing the temperature range for the blue phase, e.g., of about 100K, to appear without impairing the high molecular mobility originally expected in the liquid crystals.

To emerge the blue phase, a general nematic liquid crystal material is added with an appropriate amount of chiral dopant to be excited and twisted. The resulting low-molecular liquid crystal material is then added with a monomer, e.g., 2-ethylhexyl acrylate; EHA, and a photopolymerization initiator, e.g., 2,2-dimethoxy-2-phenyl acetophenone; DMPAP. The resulting material is subjected to photopolymerization while the blue phase being retained through careful temperature control. This accordingly widens the temperature range with which the blue phase appears to 100K or more so that the polymer-stabilized liquid crystal blue phase is formed

This blue phase is known to have the Kerr effect, which is a phenomenon of inducting the birefringence with an optical axis being the direction of an electric field. The birefringence is proportional to the square of the electric field intensity. Such a phenomenon occurs when a polarized material being isotropic is applied with an electric field. That is, the application of an electric field to the blue phase leads to local molecular orientation again depending on the intensity of the electric field with almost no change of lattice structure. The birefringence being proportionate to the square of the electric field intensity is then excited. Note here that there is a report that the Kerr coefficient of the polymer-stabilized liquid crystal blue phase is 3.7×10−10 mV −2, which is 170 times larger in size than nitrobenzene.

In terms of the Kerr effect, the polymer-stabilized liquid crystal blue phase shows both the rise and fall response times of about 10 to 100 μs. Considering the fact that the general nematic liquid crystal material has the response time of about 10 ms, the polymer-stabilized liquid crystal blue phase has a considerably fast response.

As shown in FIG. 2B, with the liquid crystal panel 40 of this embodiment, an electric field is applied between the pair of substrates 41 and 49. For the purpose, substrate pair of 41 and 49 carry, on their inner surfaces, the electrodes 42 and 48, respectively. These electrodes 42 and 48 are both made of a transparent conductive material such as ITO (Indium Tin Oxide), and are connected to an external power supply 44. Although not described in detail, one of the pair of electrodes 42 and 48 is a pixel electrode that is partitioned for every pixel, and the other is a common electrode. The pixel electrode is connected to the external power supply 44 via a switching element such as thin film transistor (TFT) for control over power application.

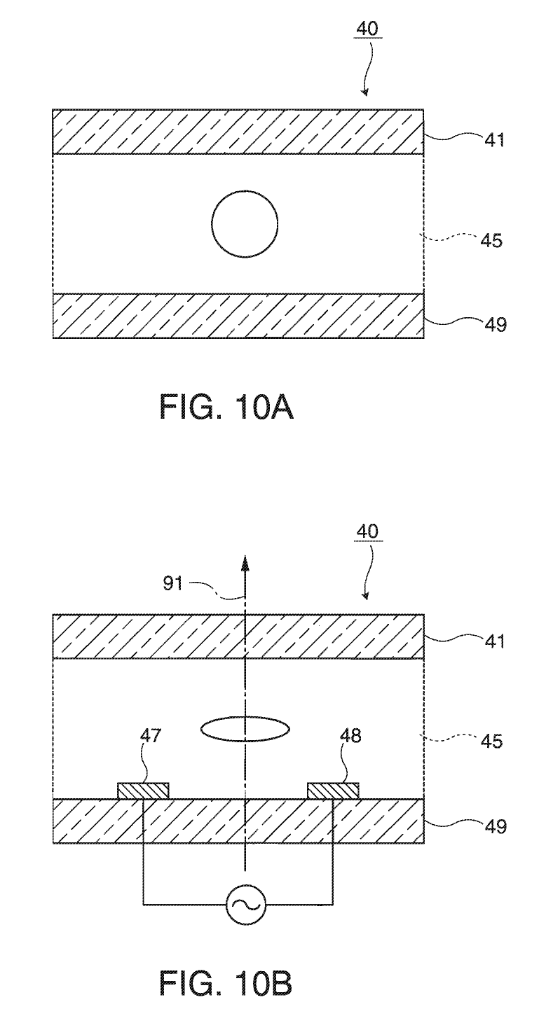

The gap between the pair of electrodes 42 and 48 is about 2 to 3 μm, while the pixel pitch is about 10 μm. Therefore, forming the pair of electrodes 42 and 48 inside of the substrate pair of 41 and 49 as shown in FIG. 2B the distance between the electrodes is shorter than forming the electrode pair of 47 and 48 at end portions of a pixel as shown in FIG. 10B. shorter distance between the electrodes leads to generation of a large electric field at a level of voltage , then the power consumption can be successfully reduced in case of forming the pair of electrodes 42 and 48 inside of the substrate pair 41 and 49.

The general liquid crystal panel controls modulates) the transmittance of incident lights utilizing the birefringence. On the other hand, with the liquid crystal panel 40 of this embodiment, an electric field is applied between a pair of substrates, and thus a principal axis of a uniaxial index ellipsoid 45b is angled 90 degrees with respect to the substrates. The liquid crystal panel 40 thus does not show the birefringence to the incident light 91 which the direction is the normal of the substrates. The liquid crystal panel 40 is thus unable to modulate the incident light 91 coming from the direction of the normal of the substrates, but is able to show the birefringence to an incident light 92 in the oblique direction of the substrates. In consideration thereof, in this embodiment, an illumination device (will be described later) is so configured that its lights are directed to enter the light valve 60 in the oblique direction with a predetermined incident angle.

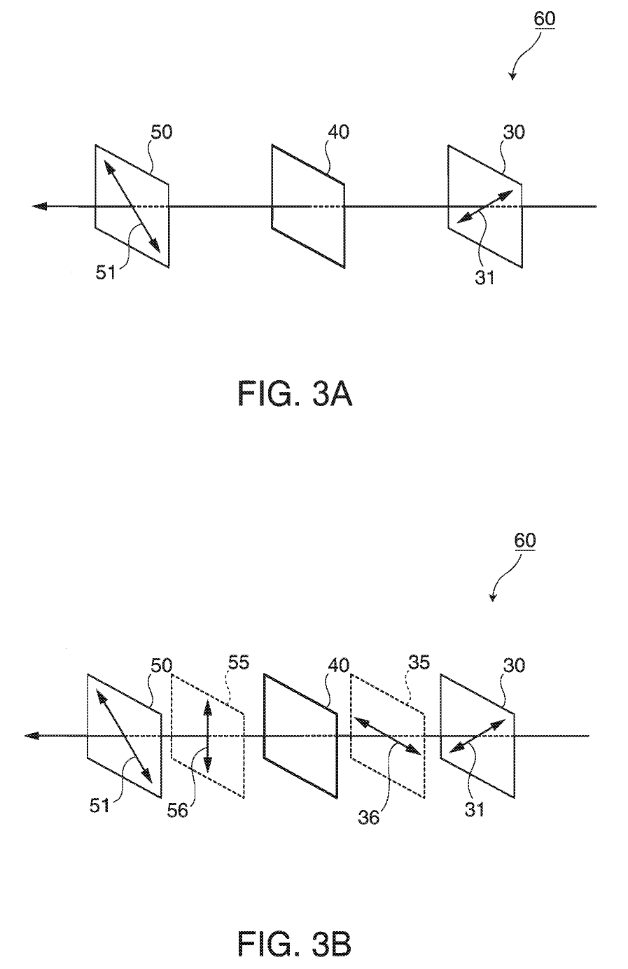

FIG. 3A is an exploded perspective view of the light valve. A pair of polarizer plates 30 and 50 are disposed before and after the liquid crystal panel 40. The polarizer plates 30 and 50 pass through only linear polarization that oscillates in the same direction as their polarization axes 31 and 51. The pair of polarizer plates 30 and 50 are disposed in such a manner that a set of the polarizer plate 30 and the polarizer axis 31 is substantially orthogonal to another set of the polarizer plate 50 and the polarizer plate 51.

In FIG. 2A, the linear polarization enters the liquid crystal panel 40 after passing through the polarizer plate 30. At this time, the linear polarization passes through the liquid crystal panel 40 because an index ellipsoid 45a of the liquid crystal phase is isotropic when no electric field is applied. Here, the linear polarization does not pass through the polarizer plate 50 because the oscillation direction of the linear polarization is orthogonal to the direction of the polarization axis of the polarizer plate 50. Accordingly, the dark display is made when no electric field is applied.

On the other hand, when an electric field is applied as shown in FIG. 2B, the index ellipsoid 45b shows the birefringence. Therefore, the linear polarization after passing through the polarizer plate 30 is converted into elliptical polarization when passing through the liquid crystal panel 40, and the elliptical polarization partially passes through the polarizer plate 50. Accordingly, the bright display is made when an electric field is applied.

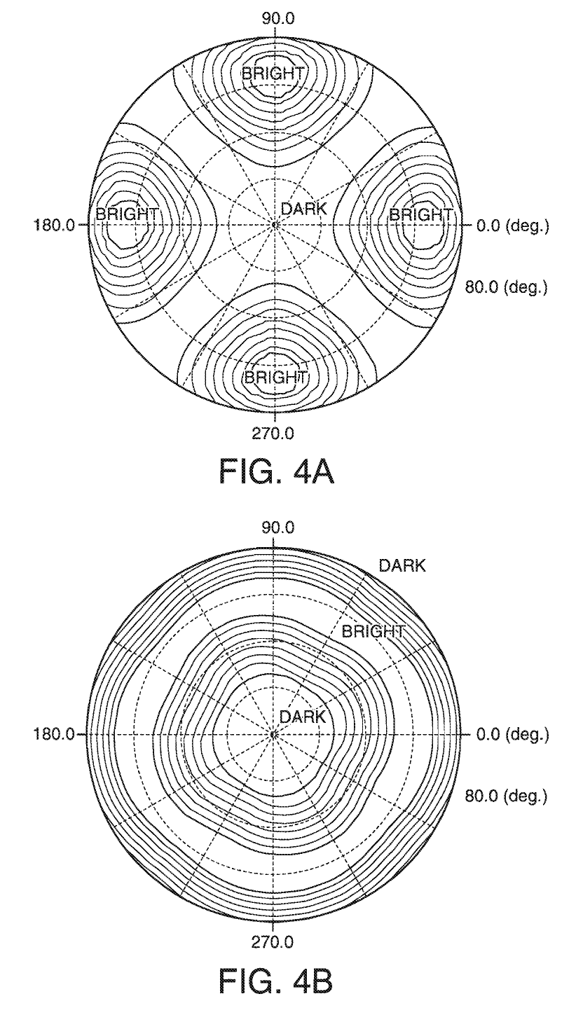

FIGS. 4A and 4B are both an iso-transmittance curve in bright display. FIG. 4A shows, as shown in FIG. 3A, a case with the light valve 60 including only the pair of polarizer plates 30 and 50 disposed before and after the liquid crystal panel 40. In this case, as shown in FIG. 4A, the light coming from the direction of a normal of the light valve is minimum in transmittance, and as the incident angle is increased, the transmittance is accordingly increased. The incident angle leading to the maximum transmittance varies depending on the retardation of the liquid crystal layer, i.e., degree of birefringence×thickness of liquid crystal layer. The light entering the light valve from the direction of the polarizer axis of the polarizer plate is not affected by birefringence, and is not converted into elliptical polarization. Therefore, the light coming from the direction of the polarizer axis of the polarizer plate becomes minimum in transmittance, and the light in the direction with an azimuth angle of substantially 45 degrees with respect to the direction of the polarizer axis of the polarizer plate becomes maximum in transmittance.

FIG. 3B is an exploded perspective view of an exemplary modified light valve. As shown in FIG. 3B, wave plates 35 and 55 are preferably disposed between the liquid crystal panel 40 and the pair of polarizer plates 30 and 50. The wave plates 35 and 55 are so disposed that their slow axes 36 and 56 form an angle of substantially 45 degrees with, respectively, the polarizer axes 31 and 51 of the polarizer plates 30 and 50. Especially, the wave plates 35 and 55 are both preferably a quarter-wave plate having a phase difference of a substantially quarter of wavelength with respect to the wavelength of any visible light. With this being the case, a circular polarizer plate is configured by the polarizer plates 30 and 50 and the wave plates 35 and 55.

The light entering the light valve 60 from the direction of the polarizer axes 31 and 51 of the polarizer plates 30 and 50 is converted into circular polarization by the wave plate 35. The circular polarization is affected by the birefringence, and is thus converted into elliptical polarization. With such conversion, the light entering the light valve 60 from the direction of the polarizer axes 31 and 51 of the polarizer plates 30 and 50 also passes through the light valve 60 as does the light coming from other directions. This accordingly enables to widen the region of bright display as shown in the iso-transmittance curve of FIG. 4B, thereby providing the image display device with the good display quality.

Illumination Device

Referring back to FIG. 1, the color systems 10 is each equipped with the Illumination device 11 that illuminates the light valve 60. The illumination device 11 includes a light source 12 and a group of lenses 13.

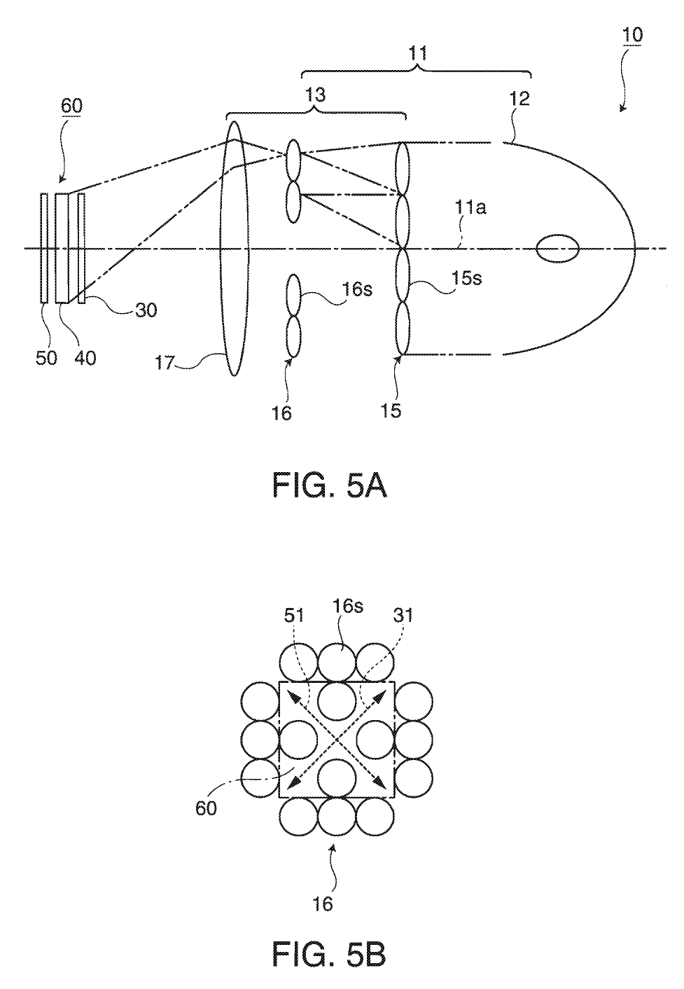

FIG. 5A is a schematic diagram showing the configuration of an illumination device in the first embodiment. The light source 12 radiates lights each in color, and is configured by a discharge lamp, a solid-state light source, or others. The solid-state light source is exemplified by a light emitting diode (LED), a laser diode (LD), and others. Alternatively, the light irradiating from a white light source may be separated into color lights by a dichroic mirror, and the color lights may be directed to the light valves of the color systems. The group of lenses 13 is configured by, in order from the side of the light source 12, a first fly eye lens 15, a second fly eye lens 16, and an superimpose lens 17.

The first fly eye lens 15 includes first small lenses 15s that are contoured substantially rectangular shape, and arranged in matrix. The first small lenses 15s each divide a collimated luminous flux coming from the light source 12 into a plurality of luminous fluxes to form images in the vicinity of the second fly eye lens 16. Herein, the first small lenses 15s are so set as to be substantially similar in outer shape to the light valve 60 when viewed from the direction of an optical axis 11a. For example, if the light valve 60 has the aspect ratio (height-to-width ratio) of 4:3, the first small lenses 15s are so set as to have the aspect ratio of about 4:3.

The second fly eye lens 16 serves to make the main beam of each of the luminous fluxes coming from the first fly eye lens 15 direct vertically to the light incident-side surface of the superimpose lens 17.

FIG. 5B is a front view of the second fly eye lens. The second fly eye lens 16 is configured by a plurality of second small lenses 16s, which are not disposed at the position corresponding to the center position of the light valve 60. That is, the second small lenses 16s are disposed at the position corresponding to the peripheral portions of the light valve 60 with a space from an optical axis of the illumination device.

The second small lenses 16s are not disposed in the direction of the polarizer axes 31 and 51 of the polarizer plates of the light valve 60. That is, the second small lenses 16s are disposed mainly in the direction that forms an azimuth angle of substantially 45 degrees with respect to the direction of the polarizer axes 31 and 51 of the polarizer plates. This configuration enables to mainly direct, to the light valve 60, the illumination light from the direction with an azimuth angle of substantially 45 degrees with respect to the direction of the polarizer axes of the polarizer plates, thereby favorably increasing the usage efficiency of the illumination light. With this being the case, there is no more need to use the above-described wave plates so that the resulting image display device can be manufactured at lower cost.

Referring back to FIG. 5A, the superimpose lens 17 serves to superimpose, on the light valve 60, the luminous fluxes coming from the second fly eye lens 16. This thus allows the entire surface of the light valve 60 to be uniformly illuminated.

As already described above, a plurality of second small lenses 16s configuring the second fly eye lens 16 are all disposed with a space from the optical axis of the illumination device 11. This thus makes the light coming from the illumination device 11 enter the light valve 60 in the oblique direction. That is, the amount of light entering the light valve 60 with a predetermined incident angle becomes larger than the amount of light entering the light valve 60 from the direction of a normal thereof. This accordingly enables to perform optical modulation by applying an electric field between a pair of substrates sandwiching therebetween a blue-phase liquid crystal material. At this time, the electric field is applied in the direction vertical to the substrates so that the aperture ratio can be increased and the power consumption can be favorably reduced compared with a case of applying the electric field in the direction toward inside of the substrates. The blue-phase liquid crystal material has a higher speed of response so that the resulting image display device can show the good moving picture. Further, the blue-phase liquid crystal material requires no orientation layer so that the light valve can have better light stability. The resulting image display device can thus offer high reliability. What is more, because the illumination light enters the light valve 60 in the oblique direction, the usage efficiency of the illumination light can be increased, and the light valve can be reduced in size.

### FIRST MODIFIED EXAMPLE

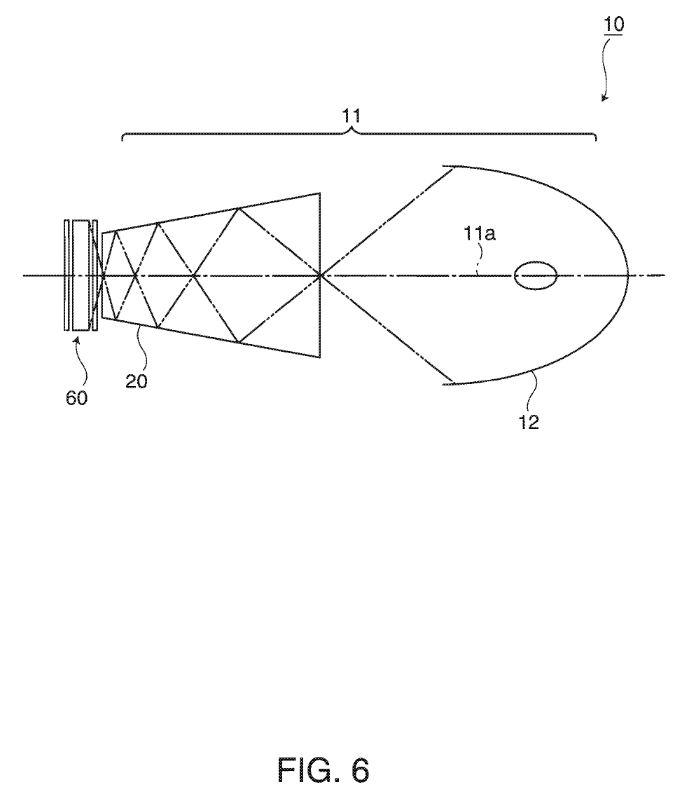

FIG. 6 is a schematic diagram showing the configuration of an illumination device in a first modified example of the first embodiment. The illumination device 11 of the first modified example includes the light source 12, and a light guide element (rod integrator) 20 that guides the light from the light source 12 to the light valve 60. This light guide element 20 is made of a transparent material such as glass, quartz, or transparent resin, and is shaped tapered like a truncated cone, a truncated pyramid, or others. The light guide element 20 is so disposed as to be tapered from the side of the light source 12 toward the side of the light valve 60.

After being radiated from the light source 12 and entering the light guide element 20, the light repeats total internal reflection on the side surface of the light guide element 20. Because the light guide element 20 is shaped tapered, the angle formed by the optical axis 11a of the light guide element 20 and the heading direction of the reflected light gradually becomes larger. As a result, the light from the illumination device 11 enters the light valve 60 in the oblique direction. With such a configuration, the amount of light entering the light valve 60 with a predetermined light incident angle becomes larger than the amount of light coming from the direction of a normal of the light valve 60. Accordingly, the effects similar to those of the first embodiment can be favorably achieved.

### SECOND MODIFIED EXAMPLE

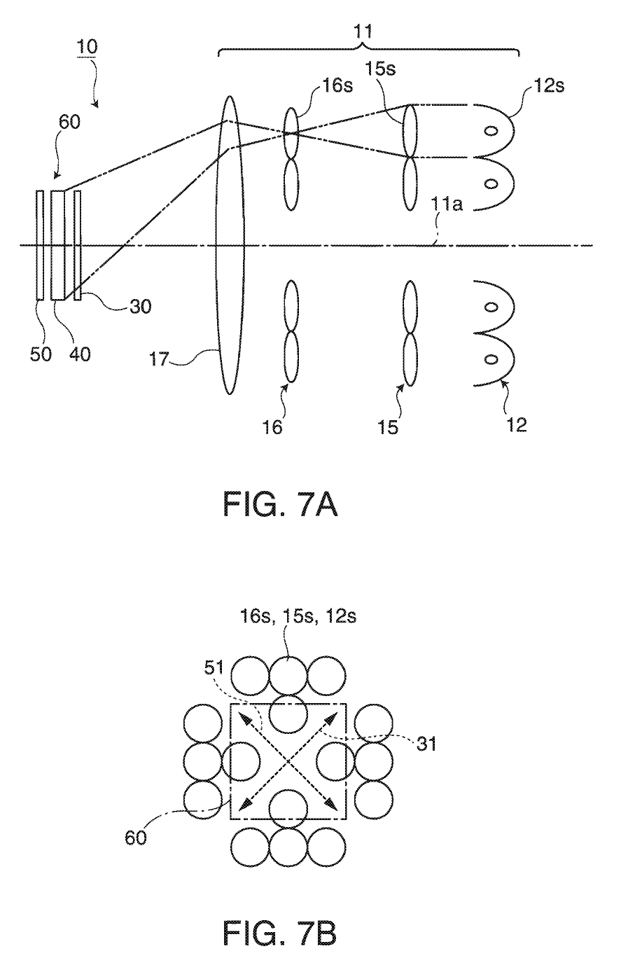

FIG. 7A is a schematic diagram showing the configuration of an illumination device in a second modified example of the first embodiment. The illumination device 11 of the second modified example includes: a plurality of small light sources 12s configuring the light source 12; the first fly eye lens 15 that gathers the luminous fluxes coming from the small light sources; the second fly eye lens 16 that collimates the main beam of each of the luminous fluxes; and an superimpose lens 17 that superimposes the luminous fluxes on the light valve 60.

FIG. 7B is a front view of the illumination device. The components, i.e., the small light sources 12s, a plurality of first small lenses 15s configuring the first fly eye lens, and a plurality of second small lenses 16s configuring the second fly eye lens, are all disposed with a space from the optical axis of the illumination device. With such a configuration, the light coming from the illumination device is directed to the light valve 60 in the oblique direction. That is, the amount of light entering the light valve 60 at a predetermined light incident angle becomes larger than the amount of light coming from the direction of a normal of the light valve 60. Accordingly, the effects similar to those of the first embodiment can be favorably achieved. Note that, with the configuration of directing the illumination light to the light valve 60 mainly in the oblique direction, it is easier to arrange a plurality of small light sources 12s in parallel compared with a case of directing the illumination light mainly from the direction of a normal of the light valve 60.

As described in the first embodiment, in the case with only a pair of polarizer plates before and after the light valve 60, the light coming from the direction of the polarizer axes 31 and 51 of the polarizer plates does not pass through the light valve 60. In this case, it is desirable to dispose the components, i.e., the small light sources 12s, the first small lenses 15s, and the second small lenses 16s, mainly in the direction with an azimuth angle of substantially 45 degrees to the direction of the polarizer axes 31 and 51 of the polarizer plates. Accordingly, the illumination light can be directed to the light valve 60 from, mainly, the direction with an azimuth angle of substantially 45 degrees with respect to the direction of the polarizer axes 31 and 51 of the polarizer plates, whereby the illumination light can be increased in usage efficiency.

### THIRD MODIFIED EXAMPLE

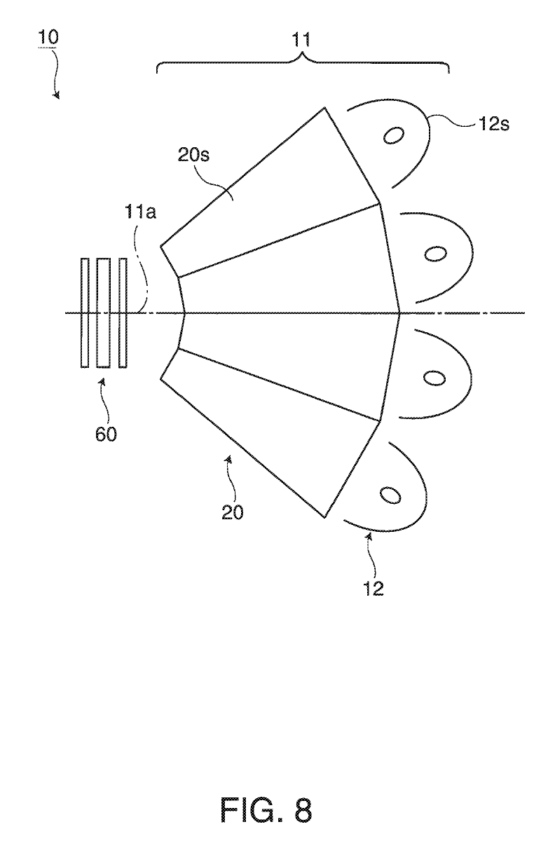

FIG. 8 is a schematic diagram showing the configuration of an illumination device in a third modified example of the first embodiment. The illumination device 11 of this third modified example includes a plurality of small light sources 12s configuring the light source 12, and a plurality of light guide elements 20s that guide the light from the small light sources to the light valve 60. The light guide element 20s are all tapered from the side of the small light sources 12s to the side of the light valve 60. The small light sources 12s and the light guide elements 20s are all disposed with a space from the optical axis 11a of the illumination device 11. This makes the light emitted from each of the light guide elements 20s direct to the light valve 60 in the oblique direction. That is, the amount of light entering the light valve 60 with a predetermined light incident angle becomes larger than the amount of light coming from the direction of a normal of the light valve 60. Accordingly, the effects similar to those of the first embodiment can be favorably achieved.

In the case with only a pair of polarizer plates before and after the light valve 60, preferably, the small light sources 12s and the light guide elements 20s are disposed mainly in the direction with an azimuth angle of substantially 45 degrees to the direction of the polarizer axes of the polarizer plates. Accordingly, the illumination light can be directed to the light valve 60 from, mainly, the direction with an azimuth angle of substantially 45 degrees with respect to the direction of polarizer axes of the polarizer plates, whereby the illumination light can be increased in usage efficiency.

Second Embodiment

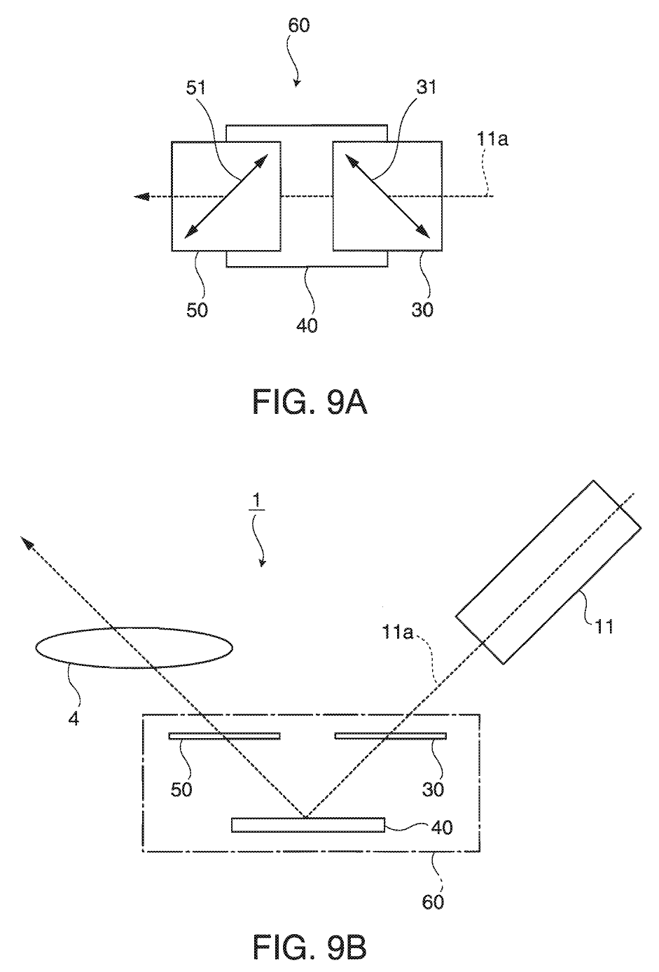

By referring to FIGS. 9A and 9B, described next is an image display device in a second embodiment of the invention.

FIG. 9A is a side view of the image display device of the second embodiment, and FIG. 9B is a plane view thereof. As shown In FIG. 9B, the image display device of the second embodiment is different from that of the first embodiment in the respect that the optical axis of the illumination device 11 is so disposed as to intersect the direction of a normal of the light valve 60. Note here that any component structure similar to that of the first embodiment is not described in detail again.

In the second embodiment, the illumination device 11 for use may be similar to the device of a related art. Although not shown in detail, the illumination device 11 includes a light source, a first fly eye lens that divides a light from the light source into a plurality of luminous fluxes for light gathering, a second fly eye lens that collimates a main beam of each of the luminous fluxes, and an superimpose lens that superimposes each of the luminous fluxes on the light valve 60. Unlike the first embodiment, second small lenses configuring the second fly eye lens are arranged in matrix with no space. This lens arrangement makes the light from the illumination device 11 substantially collimated.

Note here that a light guide element may be used as an alternative to the first fly eye lens, the second fly eye lens, and the superimpose lens. With this being the case, unlike the first modified example in the first embodiment, the light guide element is not tapered but of substantially the same shape from the side of the light source to the side of the light valve 60. This element shape makes the light emitted from the illumination device 11 substantially collimated.

The light valve 60 is configured by the liquid crystal panel 40, and the pair of polarizer plates 30 and 50. As shown in FIGS. 2A and 2B, the liquid crystal panel 40 includes the pair of substrates 41 and 49 sandwiching the blue-phase liquid crystal material 45 therebetween. Unlike the transmissive-type liquid crystal panel in the first embodiment, the second embodiment employs a reflective-type liquid crystal panel. In this case, as shown in FIG. 2B, the electrode 42 provided to the substrate 41 on the side opposite to the light incident-side of the incident light 92 is made of a metal material having the high light reflectivity, e.g., Al (aluminum), or others.

The light coming from the substrate 49 passes through the liquid crystal layer 45, is reflected by the electrode 42, passes through the liquid crystal layer 45 again, and then exits from the substrate 49. As such, with the reflective-type liquid crystal panel 40, because the incident light passes through twice the liquid crystal layer 45, the liquid crystal layer can be reduced in thickness down to about a half compared with the transmissive-type liquid crystal panel. This accordingly shortens the gap between the pair of electrodes 42 and 48, and the shorter gap leads to generation of a large electric field at a level of voltage so that the power consumption can be successfully reduced. This also increases the speed of response of the liquid crystal material so that the resulting image display device can show the good moving picture. The liquid crystal panel of the second embodiment may be of a transmissive type.

Referring back to FIG. 9B, the optical axis 11a of the illumination device 11 is so disposed as to intersect the direction of a normal of the liquid crystal panel 40. The light-incident-side polarizer plate 30 is disposed between the illumination device 11 and the liquid crystal panel 40, and the light-exiting-side polarizer plate 50 is disposed between the liquid crystal panel 40 and the projection lens 4. These polarizer panels 30 and 50 are both disposed on the optical axis of the illumination device. Note here that the polarizer plates 30 and 50 may be disposed parallelly to the liquid crystal panel 40, or disposed vertically to the optical axis 11a of the illumination device 11.

As shown in FIG. 9A, the polarizer axis 31 of the light-incident-side polarizer plate 30 is so disposed as to be substantially orthogonal to the polarizer axis 51 of the light-exiting-side polarizer plate 50. In a case where the light valve 60 is configured only by the liquid crystal panel 40 and the pair of polarizer plates 30 and 50, the polarizer plates 30 and 50 are preferably so disposed that the optical axis 11a of the illumination device forms an azimuth angle of substantially 45 degrees with respect to the direction of the polarizer axes 31 and 51 of the polarizer plates 30 and 50. This accordingly enables to increase the usage efficiency of the light coming from the illumination device.

With the image display device of the second embodiment as configured in FIG. 9B, the collimated light radiated from the illumination device 11 enters the liquid crystal panel 40 from the oblique direction. Especially with the second embodiment, it becomes possible to direct the illumination light always from the direction of achieving the maximum transmittance of the light valve. That is, the amount of light entering the light valve 60 at a predetermined incident angle becomes larger than the amount of light entering the light valve from the direction of a normal thereof. This accordingly enables to perform optical modulation by applying an electric field between a pair of substrates sandwiching therebetween a blue-phase liquid crystal material. At this time, the electric field is applied in the direction vertical to the substrates so that the aperture ratio can be increased and the power consumption can be favorably reduced compared with a case of applying the electric field in the direction horizontal to the substrates. The blue-phase liquid crystal material has a higher speed of response so that the resulting image display device can have the good characteristics of displaying moving images. Especially because the second embodiment employs the reflective-type liquid crystal panel, response can be improved to a considerable degree. Further, the blue-phase liquid crystal material requires no orientation layer so that the light valve can have better light stability. The resulting image display device can offer high reliability.

What is more, because the second embodiment can employ an illumination device similar to the device of a related art, the resulting image display device can be provided at lower cost.

While the invention has been described in detail, the foregoing description is in all aspects illustrative and not restrictive to the embodiments. It is understood that numerous other modifications and variations can be devised without departing from the scope of the invention. That is, specific materials and configurations exemplified in the embodiments are merely examples, and can be changed as appropriate.

The entire disclosure of Japanese Patent Application No. 2005-292099, filed Oct. 5, 2005 is expressly incorporated by reference herein.

What is claimed is:

1. An image display device comprising an illumination device, and a light valve that modulates a light coming from the illumination device, wherein
the light valve includes an electro-optical panel configured by a pair of substrates sandwiching therebetween an electro-optical material that shows refractive index anisotropy in response to application of an electric field when being optically isotropic,
in the electro-optical panel, the application of the electric field is directed between the pair of substrates, and
in the illumination device, an amount of light entering the light valve at a predetermined light incident angle is larger than an amount of light coming from a direction of a normal of the light valve.

2. The image display device according to claim 1, wherein
the electro-optical material turns into a liquid crystal phase at least by the application of the electric field.

3. The image display device according to claim 1, wherein
the light valve is provided with a pair of polarizer plates that are disposed before and after the electro-optical panel in an optical axis direction of the illumination device,
the pair of polarizer plates are disposed in the manner that polarizer axes thereof are substantially orthogonal to each other, and
the illumination device is configured to maximize, in the light entering the light valve, an amount of the light coming from a direction with an azimuth angle of substantially 45 degrees with respect to a direction of the polarizer axes of the polarizer plates.

4. The image display device according to claim 1, wherein
the illumination device includes:
a light source;
a first fly eye lens that divides a light from the light source into a plurality of luminous fluxes and focus the light;
a second fly eye lens that collimates a main beam of each of the luminous fluxes; and
an superimpose lens that superimposes each of the luminous fluxes on the light valve, wherein
a plurality of small lenses configuring the second fly eye lens are disposed with a space from an optical axis of the illumination device.

5. The image display device according to claim 1, wherein
the illumination device includes:
a plurality of small light sources configuring a light source;
a first fly eye lens that gathers luminous fluxes coming from the small light sources;
a second fly eye lens that collimates a main beam of each of the luminous fluxes; and
an superimpose lens that superimposes each of the luminous fluxes on the light valve, wherein
the small light sources, a plurality of first small lenses configuring the first fly eye lens, and a plurality of second small lenses configuring the second fly eye lens are each disposed with a space from an optical axis of the illumination device.

6. The image display device according to claim 5, wherein
the small light sources, the first small lenses, and the second small lenses are all disposed mainly in the direction with an azimuth angle of substantially 45 degrees with respect to a direction of a polarizer axis of a polarizer plate of the light valve.

7. The image display device according to claim 1, wherein
the illumination device includes a light source, and a light guide element that guides a light from the light source to the light valve, and
the light guide element is shaped tapered from a side of the light source toward a side of the light valve.

8. The image display device according to claim 1, wherein
the illumination device includes:
a plurality of small light sources configuring a light source; and
a plurality of light guide elements that guide a light coming from each of the small light sources to the light valve, wherein
each of the light guide elements is shaped tapered from a side of the small light sources toward a side of the light valve.

9. The image display device according to claim 1, wherein
an optical axis of the illumination device is disposed to intersect a direction of a normal of the electro-optical panel.

10. The image display device according to claim 9, wherein
the optical axis of the illumination device is disposed to form an azimuth angle of substantially 45 degrees with respect to a direction of a polarizer axis of a polarizer plate of the light valve.

11. The image display device according to claim 9, wherein
the electro-optical panel is of a reflective type.

12. The image display device according to claim 1, wherein
the light valve includes a pair of circular polarizer plates that are disposed before and after the electro-optical panel in an optical axis direction of the illumination device.

13. The image display device according to claim 12, wherein
the circular polarizer plates are configured by disposing, between the electro-optical panel and the polarizer plates, a wave plate having a phase difference of substantially a quarter wavelength with respect to a wavelength of a visible light.
